(19) United States
(12) Patent Application Publication
(10) Pub. No.: US 2024/0423767 A1
(43) Pub. Date: Dec. 26, 2024

(54) Oral Irrigator Tip

(71) Applicant: Colgate-Palmolive Company, New York, NY (US)

(72) Inventors: Jiang ZHOU, Nantong (CN); Tonny HE, Yangzhou (CN); Yanmei JI, Yangzhou (CN)

(73) Assignee: Colgate-Palmolive Company, New York, NY (US)

(21) Appl. No.: 18/690,102

(22) PCT Filed: Sep. 10, 2021
(86) PCT No.: PCT/CN2021/117554

§ 371 Date: Mar. 7, 2024

(51) Int. Cl. A61C 17/02

(52) U.S. Cl. CPC A61C 17/0202

(57) ABSTRACT

An oral irrigator tip (120) may be configured for coupling to an oral irrigator (100) for purposes of irrigating a user's teeth, gums, and interproximal regions. The oral irrigator tip (120) may have a first end (123) having an inlet (124), a second end (125) having an outlet (126), and an internal fluid passageway (128) that extends from the inlet (124) to the outlet (126). The oral irrigator tip (120) may further have an attachment portion (130) for coupling the oral irrigator tip (120) to an oral irrigator handle (110). The outlet (126) may have a polygonal shape or the outlet (220) may be elongated or the outlet (320) may include multiple outlets (321, 322, 323) that are linearly aligned.

### BACKGROUND

Water flossers, also known as oral irrigators, have increased in popularity recently due to their ease of use and effectiveness in removing plaque from interproximal areas of a user's mouth. Conventional water flossers inject water through a nozzle to clean the areas between the teeth, but the spray pattern of the water is not optimally directed to the interproximal areas. Thus, a need exists for improvements to such water flossers and/or the tips thereof to address these deficiencies.

### BRIEF SUMMARY

The present invention is directed to an oral irrigator tip for an oral irrigator. The oral irrigator tip may be configured for coupling to an oral irrigator for purposes of irrigating a user's teeth, gums, and interproximal regions. The oral irrigator tip may have a first end having an inlet, a second end having an outlet, and an internal fluid passageway that extends from the inlet to the outlet. The oral irrigator tip may further have an attachment portion for coupling the oral irrigator tip to an oral irrigator handle. The outlet may have a polygonal shape, the outlet may be elongated, or the outlet may include multiple outlets that are linearly aligned. The invention may also be directed to an oral irrigator tip kit that includes an elongated tube and a plurality of nozzle members each of which is detachably coupled to the elongated tube. Each of the nozzle members may have a differently shaped outlet to target the fluid spray for specific oral cavity features of different users.

In one aspect, the invention may be an oral irrigator tip comprising: a first end comprising an inlet and a second end comprising an outlet; an internal fluid passageway that extends from the inlet to the outlet; an attachment portion configured to couple the oral irrigator tip to an oral irrigator handle; and wherein the outlet has a polygonal shape so that the oral irrigator tip is configured to dispense a polygonal shaped fluid spray into a user's oral cavity.

In another aspect, the invention may be an oral irrigator tip comprising: a first end comprising an inlet and a second end comprising an outlet; an internal fluid passageway that extends from the inlet to the outlet; an attachment portion configured to couple the oral irrigator tip to an oral irrigator handle; and wherein the outlet is elongated so that the oral irrigator tip is configured to dispense a linear elongated fluid spray into a user's oral cavity.

In yet another aspect, the invention may be an oral irrigator tip comprising: a first end comprising an inlet and a second end comprising a plurality of outlets; an internal fluid passageway that extends from the inlet to the outlet, a proximal portion of the internal fluid passageway that comprises the inlet extending along a first axis; an attachment portion configured to couple the oral irrigator tip to an oral irrigator handle; wherein the plurality of outlets are aligned along an outlet axis that extends in a direction of the first axis, and wherein the plurality of outlets are the only outlets at the second end.

In a further aspect, the invention may be an oral irrigator tip kit comprising: an elongated tube comprising a first end comprising an inlet, a second end comprising an outlet, an internal fluid passageway that extends from the inlet to the outlet, and an attachment portion configured to couple the elongated tube to an oral irrigator handle; and a plurality of nozzle members configured to be detachably coupled to the second end of the elongated tube, each of the plurality of nozzle members comprising a nozzle inlet that is in fluid communication with the outlet of the elongated tube when the nozzle member is coupled to the elongated tube and a nozzle outlet through which a fluid is configured to be dispensed, the plurality of nozzle members comprising: a first type of nozzle comprising a first nozzle outlet having a first shape; and a second type of nozzle comprising a second nozzle outlet having a second shape, wherein the first and second shapes are different.

In still another aspect, the invention may be an oral irrigator tip comprising: a first end comprising an inlet and a second end comprising a recess region that comprises a floor that is recessed relative to the second end; an outlet located within the recess region, the outlet comprising a plurality of openings formed through the floor of the recess region; an internal fluid passageway that extends from the inlet to the outlet; and an attachment portion configured to couple the oral irrigator tip to an oral irrigator handle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an oral irrigator comprising an oral irrigator tip in accordance with an embodiment of the present invention;

FIG. 2A is a perspective view of an oral irrigator tip in accordance with an embodiment of the present invention;

FIG. 2B is a close-up perspective view of a portion of the oral irrigator tip of FIG. 2A;

FIG. 2C is a close-up front view of an outlet of the oral irrigator tip of FIG. 2A

FIG. 2D is a cross-sectional view taken along line IIC-IIC of FIG. 2A;

FIG. 3 is an illustration of the oral irrigator of FIG. 1 with the oral irrigator tip of FIGS. 2A-2C spraying fluid into interproximal areas of a user's oral cavity;

FIG. 4A is a perspective view of an oral irrigator tip in accordance with another embodiment of the present invention;

FIG. 4B is a close-up view of a portion of the oral irrigator tip of FIG. 4A;

FIG. 4C is a cross-sectional view taken along line IVC-IVC of FIG. 4A;

FIG. 5 is an illustration of the oral irrigator of FIG. 1 with the oral irrigator tip of FIGS. 4A-4C spraying fluid into interproximal areas of a user's oral cavity;

FIG. 6A is a perspective view of an oral irrigator tip in accordance with another embodiment of the present invention;

FIG. 6B is a front view of the oral irrigator tip of FIG. 6A;

FIG. 6C is a cross-sectional view taken along line VIC-VIC of FIG. 9A;

FIG. 7A is a perspective view of an oral irrigator tip in accordance with another embodiment of the present invention;

FIG. 7B is a close-up view of a portion of the oral irrigator tip of FIG. 7A;

FIG. 7C is a cross-sectional view taken along line VIIC-VIIC of FIG. 7A;

FIG. 8 is an illustration of the oral irrigator of FIG. 1 with the oral irrigator tip of FIGS. 7A-6C spraying fluid into interproximal areas of a user's oral cavity;

FIG. 9A is a perspective view of an oral irrigator tip in accordance with another embodiment of the present invention;

FIG. 9B is a front view of the oral irrigator tip of FIG. 9A; and

FIG. 9C is a cross-sectional view taken along line IXC-IXC of FIG. 9A.

FIG. 10 is an illustration of an oral irrigator tip kit including an elongated and a plurality of nozzle members that are detachably coupled to the elongated tube;

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

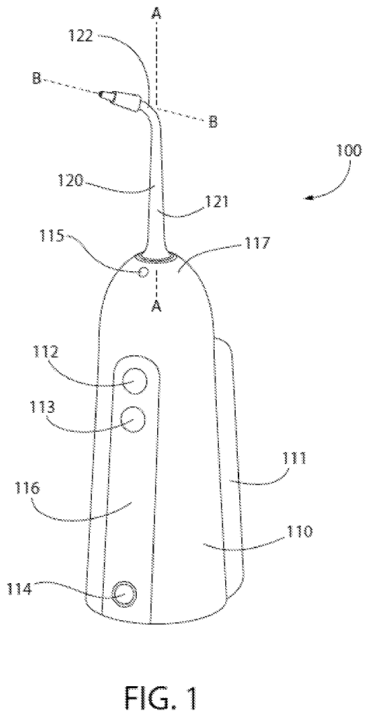

Referring first to FIG. 1, an oral irrigator 100 is illustrated in accordance with an embodiment of the present invention. The oral irrigator 100 comprises an oral irrigator handle (hereinafter “handle”) 110 and an oral irrigator tip (hereinafter “tip”) 120. The handle 110 is the portion of the oral irrigator 100 that is gripped by a user during use. Furthermore, the handle 110 has an internal cavity (not shown) that houses the various electronic components necessary for proper operation of the oral irrigator 100. Thus, for example, the handle 110 may house a power source such as a battery, a motor, a pump, and any other electronic components that may be required for operation. In some embodiments, the handle 110 may also house a processor that controls operation of the motor and the pump in accordance with a mode selected by a user. The handle 110 may include a reservoir or tank 111 that holds a supply of a fluid, such as water, that is intended to be injected or otherwise introduced into a user's oral cavity during use. In other embodiments, the handle 110 may be fluidly coupled directly to a showerhead, faucet, or other fluid source in order to be supplied with the fluid that is to be introduced into the user's oral cavity during use.

In the exemplified embodiment, the handle 110 comprises a power button 112, a mode button 113, a charging interface 114, and an unlock button 115. The power button 112 controls the on/off actuation and deactivation of the oral irrigator 100. Specifically, pressing the power button 112 either initiates activation of the motor and/or pump or initiates deactivation of the motor and/or pump. The mode button 113 enables a user to select a desired mode, such as normal mode, massage mode, high power mode, and the like. For example, upon powering on the device, the user may actuate the mode button 113 until the desired mode has been selected, and then may actuate the power button 112 again to activate the device. Of course, the user may select the mode before powering on the device in other embodiments. The charging interface 114 enables the oral irrigator 100 to be coupled to a power adaptor so that the power source of the oral irrigator 100 can be charged. The unlock button 115 may be depressed when it is desired for a user to remove the tip 120 from the handle 110. Specifically, a user may actuate the unlock button 115, which then allows the user to separate the tip 120 from the handle 110 when it is needed for replacement, cleaning, or any other purpose. The handle 110 may include a display screen 116 to display the mode, battery status, cleaning regimen information, or any other information as may be desired.

Briefly, operation of the oral irrigator 100 will be described in accordance with the exemplified embodiment. First, a user fills the reservoir 111 with a fluid, such as water. Although water is described as the fluid, in other embodiments the fluid may be mouthwash or other fluids that are desired to be introduced into the oral cavity to perform a cleaning and/or provide a therapeutic benefit to the user. Next, the user may press the power button 112 to wake up the oral irrigator 110. The pump is not operating after this initial actuation of the power button 112 in the exemplified embodiment. After the oral irrigator 110 has been woken up (i.e., activated into an initial powered state), the user may press the mode button 113 until the desired mode has been selected. The modes may be displayed on the display 116, which is located on the front face of the handle 111 in the exemplified embodiment (the display 116 could be located on the rear surface or at other locations along the handle 110 in other embodiments). The display 116 may be a screen-type display, or it may comprise a plurality of illumination elements positioned adjacent to text or other indicia indicative of the various modes. Once the desired mode has been selected, the user may press the power button 112 again, which will activate the motor and/or pump. Thus, when the user presses the power button 112 after selection of the mode, the distal end of the tip 120 which contains an outlet should be located within the user's mouth. At this point, the fluid from the reservoir 111 will flow through the tip 120 and out of the outlet of the tip 120 into the user's oral cavity. The user can move the outlet of the tip 120 along the teeth, interproximal regions, gum line, and the like to perform cleaning of those regions of the oral cavity. The oral irrigator 100 may power down automatically after a predetermined period of time, or a user may be required to press the power button 112 to power down the device after the user has completed their cleaning regimen.

As seen in FIG. 1, the handle 110 of the oral irrigator 100 has a top end 117, and the tip 120 is connected to the handle 110 at the top end 117 so that the tip 120 protrudes upwardly from the top end 117 of the handle 110. The handle 110 has an opening in the top end 117 through which the tip 120 can be inserted for purposes of coupling the tip 120 to the handle 110. The tip 120 comprises a first portion 121 that protrudes from the handle 110 along a first axis A-A and a second portion 122 that extends from the first portion along a second axis B-B that is angled relative to the first axis A-A. In the exemplified embodiment, the second axis B-B is angled upwardly with distance from the first portion 121 such that the first and second axes A-A, B-B intersect at an obtuse angle. Of course, the invention is not to be so limited and the first and second axes A-A, B-B may intersect at an acute angle or a perpendicular angle in alternative embodiments.

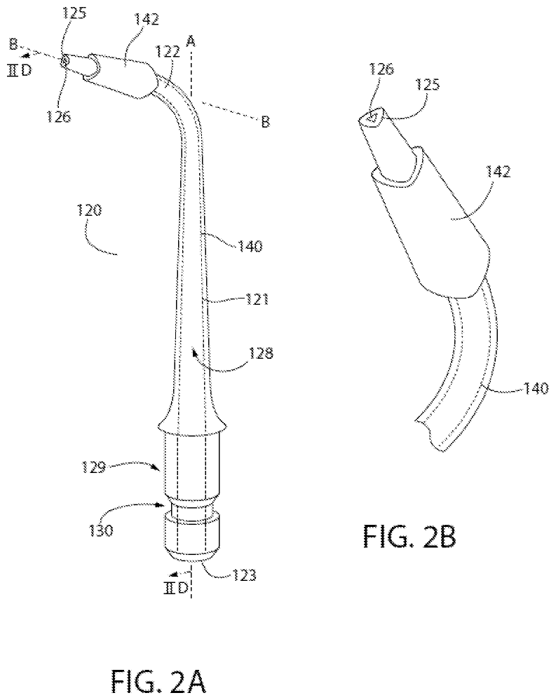

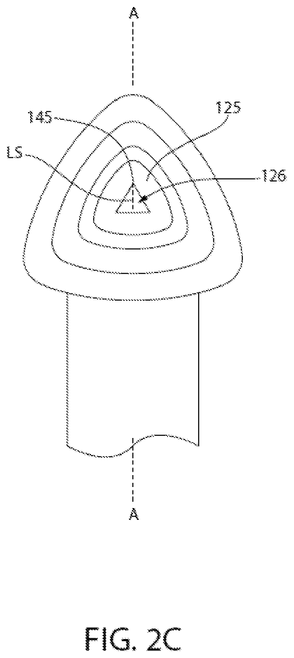

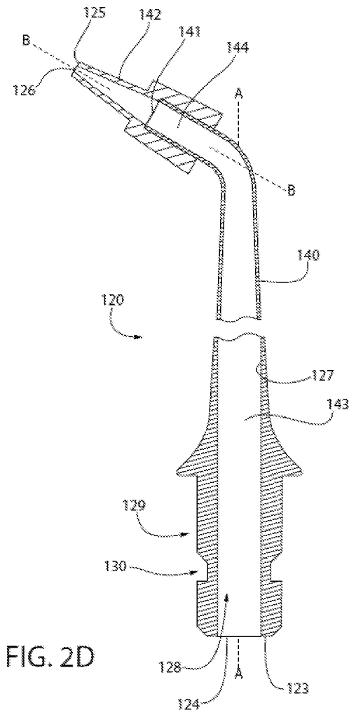

Referring to FIGS. 2A-2D, the tip 120 will be described in accordance with an embodiment of the present invention. The tip 120 comprises a first end 123 comprising an inlet 124 and a second end 125 comprising an outlet 126. The tip 120 has an inner surface 127 that defines an internal fluid passageway 128 that extends from the inlet 124 to the outlet 126. During use, the fluid flows into the internal fluid passageway 128 of the tip 120 through the inlet 124 and out of the internal fluid passageway 128 and into a user's oral cavity through the outlet 126. The fluid generally flows into the internal fluid passageway 128 due to the tip 120 being coupled to the handle 110. In that regard, the tip 120 comprises an attachment portion 129 that is configured to facilitate the coupling of the tip 120 to the handle 110. The attachment portion 129 comprises the first end 123 and the inlet 124 in the exemplified embodiment. When the tip 120 is coupled to the handle 110, the attachment portion 129 may nest within a housing of the handle 110, such as shown in FIG. 1.

The attachment portion 129 may comprise a locking feature 130 that engages with a locking feature of the handle 110 to lock the tip 120 to the handle 110. In the exemplified embodiment, the locking feature 130 is an annular notch formed into the attachment portion 129. In such an embodiment, the handle 110 may comprise a protuberance that nests within the notch when the tip 120 is coupled to the handle 110. As mentioned above, the handle 110 comprises an unlock button 115 which, when depressed, may disengage the locking feature of the handle 110 from the locking feature 130 of the tip 120. In the exemplified embodiment, depressing the unlock button 115 may retract the protuberance out of the notch so that the tip 120 can be pulled axially away from the handle 110. Of course, other locking features may be used in other embodiments including the handle 110 having a notch and the tip 120 having a protuberance. Moreover, the notch and protuberance need not be annular. In still other embodiments, the tip 120 may be coupled to the handle 110 using a threaded engagement, or even a friction/interference fit without any locking features.

In the exemplified embodiment, the tip 120 comprises an elongated tube 140 that extends from the first end 123 of the tip 120 to a distal end 141 of the elongated tube 140 and a nozzle member 142 that is coupled to the distal end 141 of the elongated tube 140. The elongated tube 140 and the nozzle member 142 collectively define the internal fluid passageway 128. The nozzle member 142 may be fixedly and non-detachably coupled to the elongated tube 140 in some embodiments. In other embodiments, the nozzle member 142 may be detachably coupled to the elongated tube 140. For example, the nozzle member 142 may be coupled to the elongated tube 140 via a threaded engagement or a simple friction fit, thereby rendering the nozzle member 142 detachable from the elongated tube 140 for purposes of replacement.

In some embodiments the elongated tube 140 may be formed from a hard plastic material and the nozzle member 142 may be formed from a resilient material, such as a rubber-like material. Because the nozzle member 142 is the part of the tip 120 that may contact the user's oral cavity surfaces directly (such as the gums), forming the nozzle member 142 from a resilient material may enhance user comfort during use. In alternative embodiments, the tip 120 may be a monolithic structure such that it includes the elongated tube 141 but omits the nozzle member 142. In such an embodiment, the elongated tube 141 comprises the outlet 126.

As noted above, the tip 120 comprises the first portion 121 that extends along the first axis A-A and the second portion 122 that extends along the second axis B-B that is angled relative to the first axis A-A. Thus, the internal fluid passageway 128 comprises a first portion (or proximal portion) 143 defined by the first portion 121 of the tip 120 and a second portion (or distal portion) 144 defined by the second portion 122 of the tip 120. The first portion 143 of the internal fluid passageway 128 comprises the inlet 124 and extends along the first axis A-A and the second portion 144 of the internal fluid passageway 128 comprises the outlet 126 and extends along the second axis B-B.

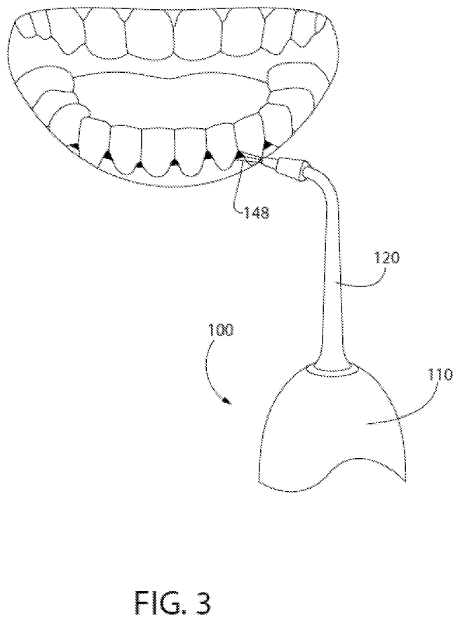

In the exemplified embodiment, the outlet 126 has a polygonal shape. That is, the outlet 126 is not round, but rather has a plurality of vertices and a plurality of sides. In the exemplified embodiment, the outlet 126 has a triangular shape. This allows the fluid dispensed through the outlet 126 to more closely fit the black triangles, or open gingival embrasures, that may form between the teeth of some individuals. The open gingival embrasures and the manner in which the triangular shape of the outlet 126 helps to target the fluid spray to those areas will be described with greater detail below with reference to FIG. 3.

As best shown in FIG. 2C, the outlet 126 has a triangular shape such that one of the vertices 145 of the triangle forms a distal-most portion of the outlet 126 (the distal-most portion referring to the portion of the outlet 126 located furthest from the inlet in the direction of the first axis A-A). Thus, the outlet 126 has the shape of an upright triangle. Moreover, the outlet 126 is illustrated as being an equilateral triangle (one with three sides of equal length), but the invention is not to be so limited in all embodiments. The outlet 126 may take the shape of an isosceles triangle (one with two sides of equal length and a third side of a different length), a scalene triangle, an acute triangle, a right triangle, or an obtuse triangle in other embodiments. However, equilateral triangles and isosceles triangles may be best suited as they may most closely match the shape of the open gingival embrasures in a user's oral cavity. A suitable isosceles triangle may have the vertex 145 forming the distal-most portion of the outlet 126 and two sides of equal length extending downwardly from the vertex 145 and a side of different length extending between the two sides of equal length and forming a proximal-most portion of the outlet 126.

In the exemplified embodiment, the vertex 145 that forms the distal-most portion of the outlet 126 is aligned with the first axis A-A. Furthermore, the outlet 126 comprises a line of symmetry LS that intersects the vertex 145 and that extends in the same direction as the first axis A-A. Again, this ensures that the outlet 126 is best shaped to match or conform to the shape of open gingival embrasures that have formed in a user's oral cavity. In one preferred embodiment, the outlet 126 is in the shape of an equilateral triangle or an isosceles triangle and oriented such that one of the vertices 145 forms a distal-most portion of the outlet 126 and a line of symmetry LS of the outlet 126 extends in the same direction as the first axis A-A of the first portion 121 of the tip 120 (and of the first portion 143 of the internal fluid passageway 128 of the tip 120).

Referring to FIG. 3, the oral irrigator 100 with the tip 120 described with reference to FIGS. 2A-2D is being used to spray a fluid into a user's oral cavity. As seen in FIG. 3, the user has open gingival embrasures, which are also referred to as black triangles because the open gingival embrasures create triangular shaped openings between adjacent teeth at the gum line. Open gingival embrasures are generally an empty space below the interproximal contact when that space is not filled with gingiva. Open gingival embrasures are not only aesthetic deficiencies, but they can also cause periodontal problems related to chronic food retention. Specifically, food, bacteria, and plaque can become trapped in these areas, which may increase a person's risk of tooth decay and gum disease. Thus, there is a specific need to remove any food particles that may become stuck in such open gingival embrasures as a preventative measure to avoid more significant dental issues. Open gingival embrasures may be caused by age, harsh dental hygiene methods, gum disease, bone loss, and the size and shape of teeth and gums.

Open gingival embrasures have a triangular shape because for many people, teeth narrow in width as they extend closer to the root. If the gums recede in this area, a triangle shaped opening remains. Thus, the tip 120 described herein with the triangle shaped outlet 126 is specifically tailored for removing plaque, bacteria, food, and any other substance trapped within the open gingival embrasures. This is because the triangle shape of the outlet 126 is designed to match the triangle shape of the open gingival embrasures. Of course, the outlet shape 126 may not perfectly match the open gingival embrasures, but it is possible for a user to be able to choose from a selection of tips 120 having outlets with different triangular shapes to try to match the shape of their specific open gingival embrasures. As seen in FIG. 3, the tip 120 is configured to dispense a fluid spray 148 into the user's oral cavity, and more specifically into the open gingival embrasures or other interproximal teeth regions. The fluid spray 148 has a polygonal, or more specifically triangular shape that matches the shape of the outlet 126, and hence also matches the shape of the open gingival embrasures. This enables the oral irrigator 100 to more effectively clear food, bacteria, and plaque from the open gingival embrasures.

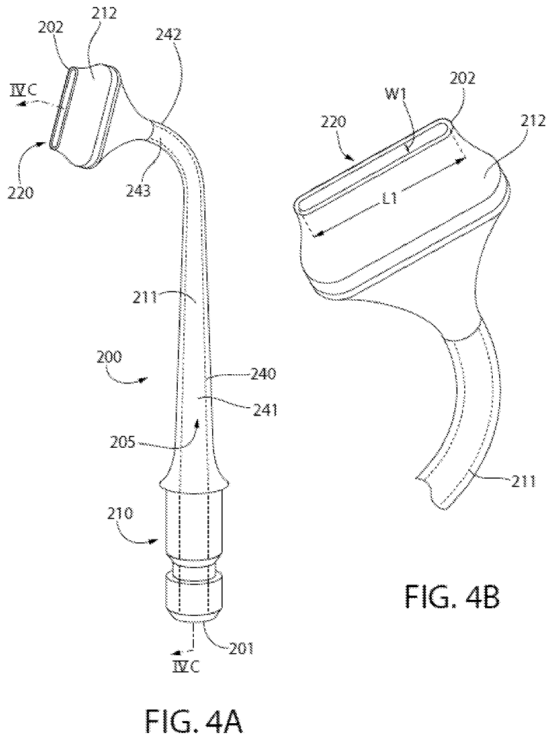

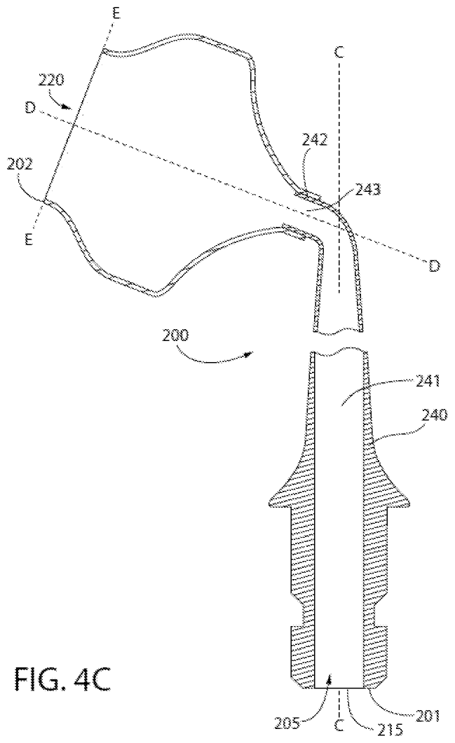

Referring to FIGS. 4A-4C, an oral irrigator tip (hereinafter “tip”) 200 will be described in accordance with another embodiment of the present invention. The tip 200 is generally similar to the tip 120, except with regard to the shape and configuration of the outlet. Thus, details of the tip 120 provided above are entirely applicable to the tip 200 unless a different feature associated with the tip 200 is specifically noted herein.

The tip 200 comprises an attachment portion 210 that is configured to couple the tip 200 to an oral irrigator handle (such as the handle 110 of FIG. 1). Furthermore, the tip 200 defines an internal fluid passageway 205 that extends from an inlet 215 at a first end 201 of the tip 200 to an outlet 220 at a second end 202 of the tip 200. Fluid flows from the handle 110 to the inlet 215 and then through the internal fluid passageway 205 to the outlet 220 where it is dispensed or sprayed into a user's oral cavity to clean the gums and interproximal regions. The tip 200 comprises an elongated tube 211 and a nozzle member 212 as described in the prior embodiment. The nozzle member 212 may be detachably coupled to the elongated tube 211 via a threaded engagement, a friction fit, or any other technique. Alternatively, the nozzle member 212 may be fixedly coupled to the elongated tube 211. In still other embodiments, the nozzle member 212 may be omitted and the elongated tube 211 may be a unitary structure which includes the inlet 215 and the outlet 220. The elongated tube 211 may be formed from a hard plastic and the nozzle member 212 may be formed from a resilient material such as rubber similar to that described above with reference to the tip 120.

The tip 200 comprises a first portion or proximal portion 240 that defines a first or proximal portion 241 of the internal fluid passageway 205 and a second portion or distal portion 242 that defines a second or distal portion 243 of the internal fluid passageway 205. The proximal portion 241 of the internal fluid passageway 205 comprises the inlet 215 and the distal portion 243 of the internal fluid passageway 205 comprises the outlet 220. The proximal portion 241 of the internal fluid passageway 205 extends along a first axis C-C and the distal portion 243 of the internal fluid passageway 205 extends along a second axis D-D. The second axis D-D is angled relative to the first axis C-C. In the exemplified embodiment, the second axis D-D intersects the first axis C-C at an obtuse angle, although the invention is not to be so limited in all embodiments and the second axis D-D may intersect the first axis C-C at a perpendicular angle or an acute angle in other embodiments. The exact angle at which the distal portion 242 is oriented relative to the proximal portion 240 is not to be limiting of the invention in all embodiments.

In this embodiment, the outlet 220 is elongated. More specifically, the outlet 220 is in the shape of an elongated oval. The outlet 220 has a width W1 and a length L1, whereby the length L1 is at least four times greater than the width W1. In some embodiments, the length L1 may be at least five times, or at least six times, or at least seven times, or at least eight times, or at least nine times, or at least ten times greater than the width W1. In some embodiments, the width W1 may be between 0.2 mm and 0.5 mm and the length L1 may be between 2 mm and 3 mm. In other embodiments, the width W1 may be between 0.2 mm and 0.3 mm and the length L1 may be between 2.6 mm and 2.9 mm. In still other embodiments, the width W1 may be about 0.25 mm and the length L1 may be about 2.75 mm (with the term about allowing for a tolerance of up to 3%). When the width W1 is 0.25 mm and the length L1 is 2.75 mm, the length L1 is eleven times greater than the width W1. Stated another way, in one embodiment a ratio of the length L1 to the width W1 is between 4:1 and 11:1, and in one particular embodiments the ratio is 11:1.

The outlet 220 is a single, continuous opening formed into the second end 202 of the tip 200. That is, in this embodiment the outlet 220 is not formed by multiple openings, but is instead one continuous opening. In fact, the single opening of the outlet 220 is the only opening formed into the second end 202 of the tip 200. Thus, all fluid flowing through and being sprayed out of the tip 200 is dispensed through the outlet 220. The outlet 220 is elongated in a direction of the axis C-C. Specifically, the outlet 220 is elongated along an outlet axis E-E. The outlet axis E-E is not parallel to or coincident with the first axis C-C, but it extends in generally the same direction as the first axis C-C. The outlet axis E-E intersects the first axis C-C at an acute angle.

As mentioned above, the outlet 220 is elongated in the direction of the first axis C-C. In the context of this invention, this means that the length L of the outlet 220 extends generally in the direction of the first axis C-C. In some embodiments, the length L of the outlet 220 may extend in a direction that is parallel to the first axis C-C. However, this is not the case in the exemplified embodiment. Rather, in the exemplified embodiment the outlet 220 is elongated in a direction of the first axis C-C, but is oriented at an angle relative to the first axis C-C. Thus, as used herein, the outlet 220 may be considered elongated in the direction of the first axis C-C if the outlet axis E-E intersects the first axis C-C at an angle that is less than 45° or the outlet axis E-E is parallel to the first axis C-C. This ensures that when the oral irrigator 100 is in use, the outlet 220 will be elongated along the interproximal spaces between adjacent teeth so that the fluid sprayed from the outlet 220 is directed onto the interproximal regions.

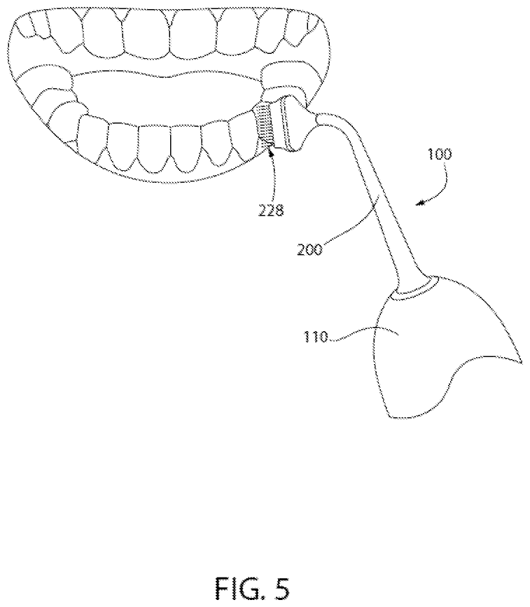

Referring to FIG. 5, the oral irrigator 100 of FIG. 1 with the oral irrigator tip 200 of FIGS. 4A-4C is illustrated being used to spray a fluid into interproximal regions of a user's oral cavity. As seen, if a user is holding the handle 110 of the oral irrigator 100 in a natural way with the handle 120 in a generally upright vertical orientation, the outlet 220 of the tip 200 is elongated vertically, which is the same direction as the line where two adjacent teeth touch (i.e., the interproximal space or cavity). As a result, the fluid spray 228 exiting the outlet 220 is elongated and vertically oriented so that the fluid spray 228 will contact the entire interproximal space between two adjacent teeth simultaneously. The user can therefore hold the oral irrigator 200 with the outlet 220 in one place to sufficiently irrigate each interproximal space. In particular, the user can hold the outlet 220 in one place rather than having to move the outlet 220 upwardly/downwardly along the interproximal region to cover the entire interproximal region with the fluid spray 228. The user can then move the outlet 220 to another interproximal region and do the same until all interproximal regions between each pair of adjacent teeth have been irrigated and cleaned of food particles, bacteria, plaque, and the like.

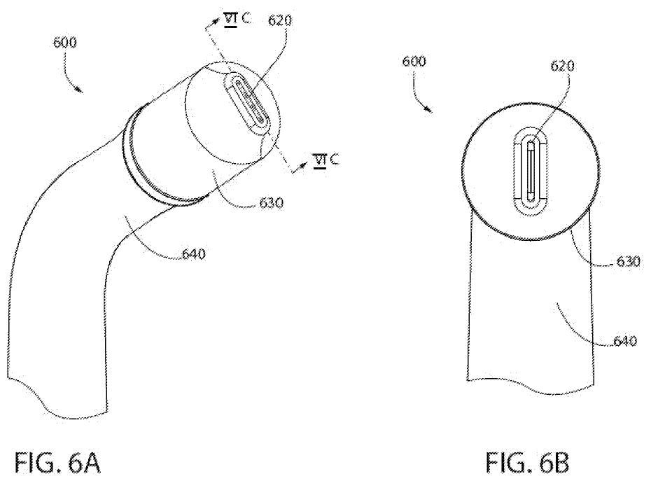

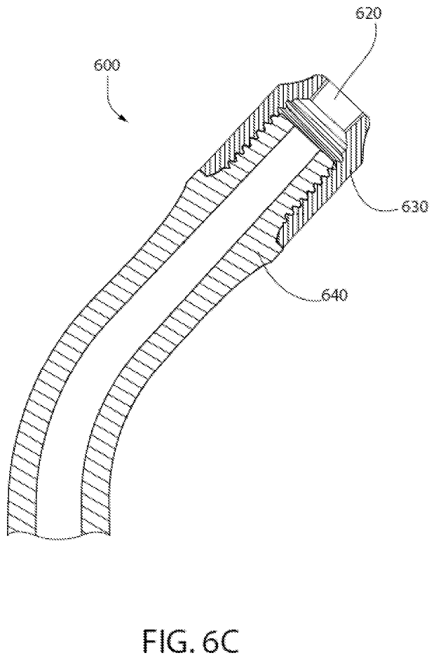

FIGS. 6A-6C illustrate an oral irrigator tip 600 in accordance with another embodiment of the present invention. This embodiment is very similar to the tip 200 and thus the details provided above with reference to the tip 200 in FIGS. 4A-4C is entirely applicable, except the minor differences as apparent from the drawings. In particular, in this embodiment the outlet 620 is narrower in width and shorter in length as compared to the tip 200. The outlet 620 has a length to width ratio of between 8:1 and 12:1. In particular, the tip 600 is the same as the tip 200 except it has a thinner outlet 620 and a smaller head size which is better suited for precision cleaning. Moreover, in this embodiment the tip 600 includes a nozzle member 630 that is detachably coupled to a main body portion 640. In particular, in this embodiment the nozzle member 630 is coupled to the main body portion 640 via threads. Of course, other mechanisms for attachment may be used in other embodiments, such as friction fit, protuberance/recess, and the like. Moreover, the nozzle portion 630 may be integral and non-detachable from the main body portion 640 in other embodiments.

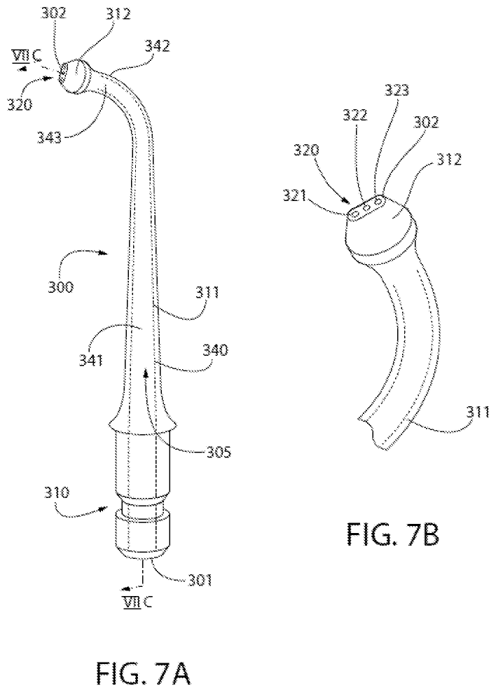

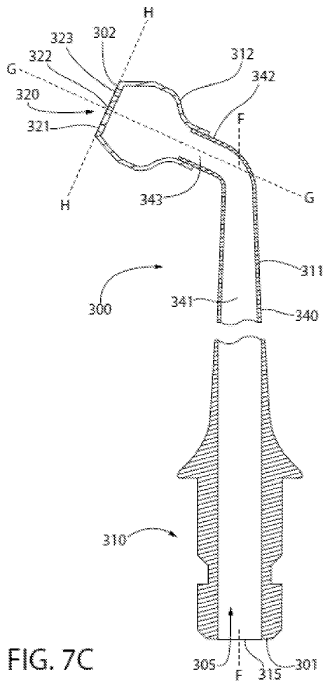

Referring to FIGS. 7A-7C, an oral irrigator tip (hereinafter “tip”) 300 is illustrated in accordance with an embodiment of the present invention. As with the tip 200, the tip 300 is very similar to the tip 120 described above with reference to FIGS. 2A-2D, except with regard to the configuration and structure of its outlet. Thus, the description of the tip 120 provided above is applicable to the tip 300 except with regard to the differences specifically noted herein.

The tip 300 comprises an attachment portion 310 that is configured to couple the tip 300 to an oral irrigator handle (such as the handle 110 of FIG. 1). Furthermore, the tip 300 defines an internal fluid passageway 305 that extends from an inlet 315 at a first end 301 of the tip 300 to an outlet 320 at a second end 302 of the tip 300. Fluid flows from the handle 110 to the inlet 315 and then through the internal fluid passageway 305 to the outlet 320 where it is dispensed or sprayed into a user's oral cavity to clean the gums and interproximal regions. The tip 300 comprises an elongated tube 311 and a nozzle member 312 as described in the prior embodiment. The nozzle member 312 may be detachably coupled to the elongated tube 311 via a threaded engagement, a friction fit, or any other technique. Alternatively, the nozzle member 312 may be fixedly coupled to the elongated tube 311. In still other embodiments, the nozzle member 312 may be omitted and the elongated tube 311 may be a unitary structure which includes the inlet 315 and the outlet 320. The elongated tube 311 may be formed from a hard plastic and the nozzle member 312 may be formed from a resilient material such as rubber similar to that described above with reference to the tip 120.

The tip 300 comprises a first portion or proximal portion 340 that defines a first or proximal portion 341 of the internal fluid passageway 305 and a second portion or distal portion 342 that defines a second or distal portion 343 of the internal fluid passageway 305. The proximal portion 341 of the internal fluid passageway 305 comprises the inlet 315 and the distal portion 343 of the internal fluid passageway 305 comprises the outlet 320. The proximal portion 341 of the internal fluid passageway 305 extends along a first axis F-F and the distal portion 343 of the internal fluid passageway 305 extends along a second axis G-G. The second axis G-G is angled relative to the first axis F-F. In the exemplified embodiment, the second axis G-G intersects the first axis F-F at an obtuse angle, although the invention is not to be so limited in all embodiments and the second axis G-G may intersect the first axis F-F at a perpendicular angle or an acute angle in other embodiments. The exact angle at which the distal portion 342 is oriented relative to the proximal portion 340 is not to be limiting of the invention in all embodiments.

The second end 302 of the tip 300 is planar and extends along an outlet axis H-H. In the exemplified embodiment, the outlet axis H-H intersects the first axis F-F at an acute angle. However, the invention is not to be so limited in all embodiments and in other embodiments the outlet axis H-H may be oriented parallel to the first axis F-F. In preferred embodiments, the outlet axis H-H is either parallel to the first axis F-F or intersects the first axis F-F at an angle of 45° or less, and thus the outlet axis H-H extends in generally the same direction as the first axis F-F, as described above. In some embodiments, the outlet axis H-H extends in a generally vertical direction, which may be perpendicular to a horizontal plane or may intersect a horizontal plane at an acute angle.

The outlet 320 comprises a plurality of openings 321, 322, 323. In the exemplified embodiment, there are three openings 321, 322, 323 which form the outlet 320. However, in other embodiments the outlet 320 may comprise more than three openings (e.g., four openings or five openings, for example, although more are still possible). The openings 321, 322, 323 of the outlet 320 are linearly and vertically aligned. The openings 321, 322, 323 of the outlet 320 are all located on the outlet axis H-H. There are no openings in the second end 302 of the tip 300 other than the openings 321, 322, 323 of the outlet 320 that are located on the outlet axis H-H. Thus, the openings 321, 322, 323 of the outlet 320 are the only openings at the second end of the tip 320.

In the exemplified embodiment, each of the openings 321, 322, 323 of the outlet 320 has the same shape, the same diameter, and the same cross-sectional area. Thus, the openings 321, 322, 323 are identical in size and shape, and only differ with respect to their specific location at the second end 302 of the tip 300. This makes the spray of fluid that exits the tip 300 via the openings 321, 322, 323 consistent and effective. In the exemplified embodiment, the second end 302 of the tip 300 is an elongated oval shape, and the openings 321, 322, 323 are arranged in a spaced apart manner along the elongated oval shape of the second end 302. The openings 321, 322, 323 may have a diameter which is greater than half of a width of the second end 302 of the tip 300, such that additional openings 321, 322, 323 having the same size and shape as the openings 321, 322, 323 could not be added to the second end 302 of the tip 300. Thus, the openings 321, 322, 323 of the outlet 320 are the only openings through which the fluid can exit the tip 300, and the openings 321, 322, 323 are all vertically aligned on the outlet axis H-H. In some embodiments, the diameters of the openings 321, 322, 323 may be between 0.3 mm and 0.75 mm, more specifically between 0.4 mm and 0.5 mm, and still more specifically about 0.45 mm (about including a tolerance of up to plus or minus 3%).

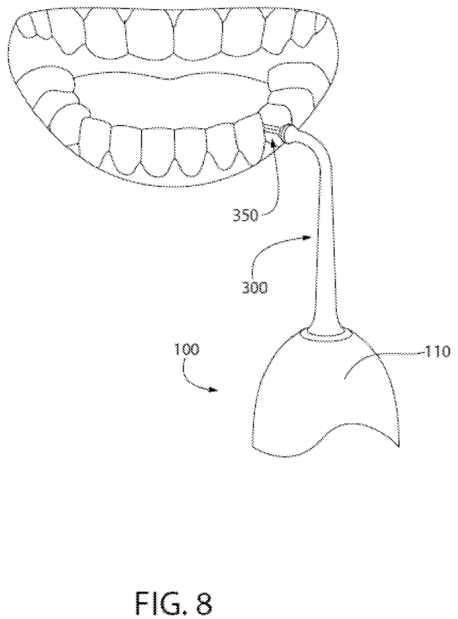

FIG. 8 illustrates the oral irrigator 100 of FIG. 1 comprising the handle 110 of FIG. 1 and the tip 300 of FIGS. 7A-7C. A fluid spray 350 is dispensed through the outlet 320 at the second end 302 of the tip 300. The fluid spray 350 is a linear and vertically oriented spray that is configured to be sprayed into interproximal regions of a user's oral cavity to clear such interproximal regions of debris such as food particles, bacteria, plaque, and the like. Thus, the tip 300 operates in much the same way as the tip 200, except that the tip 300 includes multiple smaller openings 321, 322, 323 that are vertically and linearly arranged whereas the tip 200 includes a single vertically elongated outlet 220.

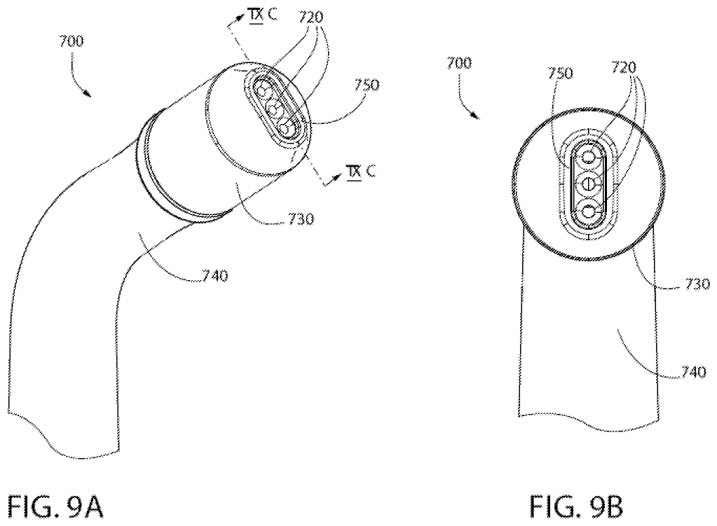

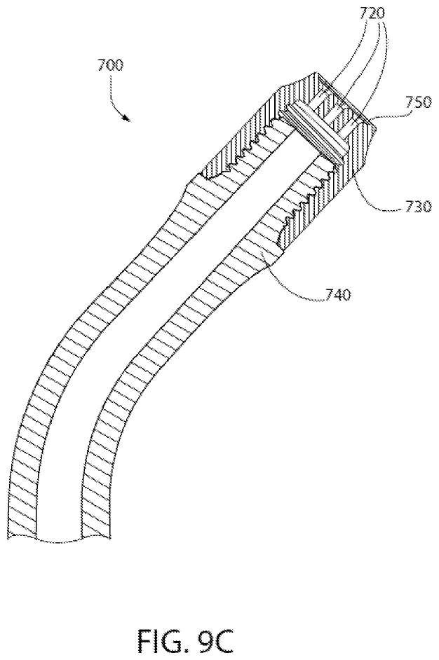

FIGS. 9A-9C illustrate an oral irrigator tip 700 in accordance with another embodiment of the present invention. The oral irrigator tip 700 is very similar to the oral irrigator tip 300 of FIGS. 7A-7C, and thus the details provided above with reference to the tip 200 in FIGS. 7A-7C is entirely applicable, except the minor differences as apparent from the drawings. One main difference is that in this embodiment, the outlet 720 (which comprises a plurality of vertically aligned openings, which includes three outlets in the exemplified embodiment but could include four or five outlets in other embodiments) is formed into a recess region 750 located at the distal end of the tip 700. That is, the openings of the outlet 720 are recessed relative to the distal-most part of the tip 700. This allows a user to potentially contact an oral cavity surface (i.e., a tooth or gum surface) with the distal-most part of the tip 700 without affecting the flow of the fluid as it exits the outlet 720. Moreover, in this embodiment the tip 700 includes a nozzle member 730 that is detachably coupled to a main body portion 740. In particular, in this embodiment the nozzle member 730 is coupled to the main body portion 740 via threads. Of course, other mechanisms for attachment may be used in other embodiments, such as friction fit, protuberance/recess, and the like. Moreover, the nozzle portion 730 may be integral and non-detachable from the main body portion 740 in other embodiments.

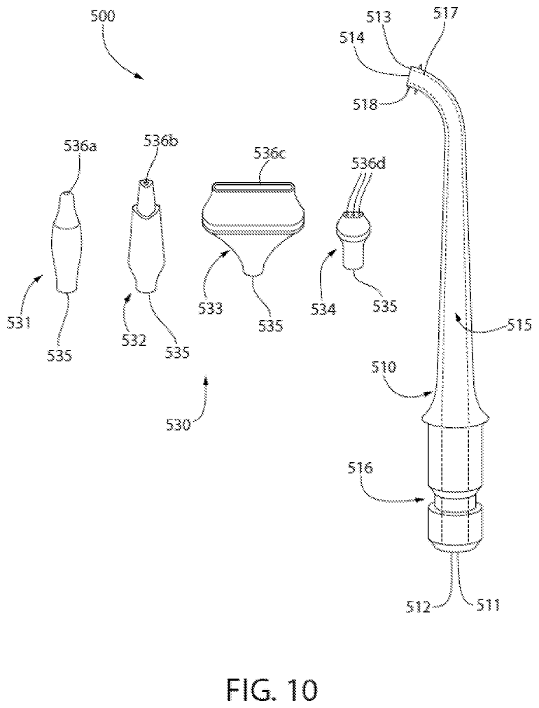

Referring to FIG. 10, an oral irrigator tip kit 500 is illustrated in accordance with an embodiment of the present invention. The oral irrigator tip kit 500 comprises an elongated tube 510 and a plurality of nozzle members 530 each of which is detachably coupled to the elongated tube 510. This allows a user to simply change the nozzle member 530 on the end of the elongated tube 510 to change the spray pattern rather than changing out the entire tip.

The elongated tube 510 comprises a first end 511 having an inlet 512 and a second end 513 having an outlet 514. Furthermore, the elongated tube 510 comprises an internal fluid passageway 515 that extends from the inlet 512 to the outlet 514. The elongated tube 510 also comprises an attachment portion 516 that is configured to couple the elongated tube 510 to an oral irrigator handle, such as the handle 110 of FIG. 1. The attachment portion 516 may be similar or identical to the attachment portions of the embodiments previously described, and thus the description of the prior tips is applicable for that structure. The elongated tube 510 may be made of a hard plastic material in some embodiments, although the invention is not to be so limited in all embodiments and the elongated tube 510 could be formed from a resilient or flexible material in other embodiments.

The elongated tube 510 comprises a distal portion 517 which comprises the second end 513 and the outlet 514. The distal portion 517 of the elongated tube 510 may comprise a connection feature 518 to facilitate the attachment of the plurality of nozzle members 530 to the elongated tube 510. In the exemplified embodiment, the connection feature 518 comprises an external screw thread that is configured to engage an internal screw thread of the nozzle members 530. However, the invention is not to be so limited in all embodiments and the connection feature 518 may take on other structure forms, including being a protuberance that nests within a groove in the nozzle members 530, a groove within which a protuberance of the nozzle members 530 nests, or any other feature. Furthermore, in other embodiments the connection feature 518 may be omitted and the nozzle members 530 may be coupled to the distal portion 517 of the elongated tube 510 via a friction fit or an interference fit. However, it may be preferable to have a physical or mechanical interlocking structure between the nozzle members 530 and the elongated tube 510 to prevent the nozzle members 530 from becoming detached from the elongated tube 510 during normal use.

The oral irrigator tip kit 500 comprises the plurality of nozzle members 530 for attachment to the elongated tube 510 at a distal end 517 of the elongated tube 510. In the exemplified embodiment, the plurality of nozzle members 530 comprises a first nozzle member 531, a second nozzle member 532, a third nozzle member 533, and a fourth nozzle member 534. In other embodiments, the kit 500 may include just two or just three of the nozzle members 530, or it may include more than the four nozzle members 530 that are shown in FIG. 10. Each of the nozzle members 531-534 comprises a connection feature 535 that is configured to connect the nozzle members 531-534 to the distal portion 517 of the elongated tube 510. As mentioned above, this connection feature 535 may be internal threads, notches, protuberances, or any other feature that can facilitate the secure attachment of the nozzle member 531-534 to the elongated tube 510.

Each of the nozzle members 531-534 comprises a nozzle outlet 536a-d through which the fluid is configured to be dispensed during use. More specifically, the nozzle outlets 536a-d of each of the nozzle members 531-534 are different from one another. Thus, the nozzle member 531 comprises the nozzle outlet 536a which is a circular shaped outlet. The nozzle member 532 comprises the nozzle outlet 536b which is a polygonal shaped outlet, and more specifically a triangular shaped outlet, like the tip 120. The nozzle member 533 comprises the nozzle outlet 536c which is elongated, and more specifically an elongated oval much like the tip 200. The nozzle member 534 comprises the nozzle outlet 536d which comprises a plurality of openings that are aligned on an axis, much like the tip 300. Thus, the shapes of each of the nozzle outlets 536a-d are different from one another. As a result, a user can swap out one nozzle member 531-534 for another by detaching one nozzle member 531-534 from the elongated tube 510 and replacing it with another one of the nozzle members 531-534 to change the spray pattern.

The oral irrigator tip kit 500 may be sold together in a package. Thus, the elongated tube 510 may be sold together in a package with any of two or more of the nozzle members 531-534. The elongated tube 510 may be formed from a rigid material and the nozzle members 531-534 may be formed from a resilient material, as has been described herein with reference to some of the earlier described embodiments. The end user can decide which particular nozzle member 531-534 to attach to the elongated tube 510 depending on the spray pattern which is optimal for cleaning that person's oral cavity.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. An oral irrigator tip comprising:
a first end comprising an inlet and a second end comprising an outlet;
an internal fluid passageway that extends from the inlet to the outlet;
an attachment portion configured to couple the oral irrigator tip to an oral irrigator handle; and
wherein the outlet has a polygonal shape so that the oral irrigator tip is configured to dispense a polygonal shaped fluid spray into a user's oral cavity.

2. The oral irrigator tip according to claim 1 further comprising:
an elongated tube comprising the first end of the oral irrigator tip and a distal end; and
a nozzle member coupled to the distal end of the elongated tube, the nozzle member comprising the outlet.

3. (canceled)

4. The oral irrigator tip according to claim 2 wherein the nozzle member is detachably coupled to the elongated tube.

5. The oral irrigator tip according to claim 1 wherein the internal fluid passageway comprises a first portion that comprises the inlet and extends along a first axis and a second portion that comprises the outlet and extends along a second axis that is angled relative to the first axis.

6. The oral irrigator tip according to claim 1 wherein the outlet comprises a plurality of vertices and a plurality of sides, and wherein one of the plurality of vertices forms a distal-most part of the outlet.

7. The oral irrigator tip according to claim 1 wherein the outlet has a triangular shape so that the oral irrigator tip is configured to dispense a triangular shaped fluid spray into the user's oral cavity.

8. The oral irrigator tip according to claim 7 wherein the internal fluid passageway comprises a first portion that comprises the inlet and extends along a first axis and a second portion that comprises the outlet and extends along a second axis that is angled relative to the first axis, wherein the triangular shape of the outlet has a vertex that forms a distal-most part of the outlet, wherein the outlet comprises a line of symmetry that extends in a direction of the first axis, and wherein the triangular shape of the outlet is an equilateral triangle or an isosceles triangle.

9. An oral irrigator tip comprising:
a first end comprising an inlet and a second end comprising an outlet;
an internal fluid passageway that extends from the inlet to the outlet;
an attachment portion configured to couple the oral irrigator tip to an oral irrigator handle; and
wherein the outlet is elongated so that the oral irrigator tip is configured to dispense a linear elongated fluid spray into a user's oral cavity.

10. The oral irrigator tip according to claim 9 wherein the outlet comprises a single continuous opening in the second end, and wherein the outlet is the only outlet located at the second end.

11. The oral irrigator tip according to claim 9 wherein the internal fluid passageway comprises a proximal portion that extends from the inlet towards the outlet along a first axis, and wherein the outlet is elongated in a direction of the first axis.

12. The oral irrigator tip according to claim 11 wherein the outlet is elongated along an outlet axis that intersects the first axis at an acute angle.

13. The oral irrigator tip according to claim 11 wherein the internal fluid passageway comprises a distal portion that extends from the proximal portion to the outlet along a second axis that is angled relative to the first axis.

14. (canceled)

15. The oral irrigator tip according to claim 9 wherein the outlet is in a shape of an elongated oval.

16. The oral irrigator tip according to claim 9 further comprising:
an elongated tube comprising the first end of the oral irrigator tip and a distal end; and
a nozzle member coupled to the distal end of the elongated tube, the nozzle member comprising the outlet.

17. The oral irrigator tip according to claim 16 wherein the nozzle member is detachably coupled to the elongated tube

18. An oral irrigator tip comprising:
a first end comprising an inlet and a second end comprising an outlet, the outlet comprising a plurality of openings;
an internal fluid passageway that extends from the inlet to the outlet, a proximal portion of the internal fluid passageway that comprises the inlet extending along a first axis;
an attachment portion configured to couple the oral irrigator tip to an oral irrigator handle;
wherein the plurality of openings of the outlet are aligned along an outlet axis that extends in a direction of the first axis, and
wherein the plurality of openings of the outlet are the only openings at the second end.

19. The oral irrigator tip according to claim 18 wherein the outlet axis intersects the first axis at an acute angle.

20. The oral irrigator tip according to claim 18 wherein each of the plurality of openings has the same shape and cross-sectional area.

21. (canceled)

22. The oral irrigator tip according to claim 18 wherein the oral irrigator tip is configured to dispense a linear fluid spray from the outlet into a user's oral cavity

23. The oral irrigator tip according to claim 18 wherein the oral irrigator tip comprises a distal end, and further comprising a recess in the distal end, wherein the openings of the outlet are located within the recess in the distal end.

24.-33. (canceled)
